(19) United States
(12) Patent Application Publication
(10) Pub. No.: US 2006/0221048 A1
(43) Pub. Date: Oct. 5, 2006

(54) Image processing apparatus

(75) Inventor: Norikazu Nagasawa, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/394,236

(22) Filed: Mar. 31, 2006

(30) Foreign Application Priority Data
Mar. 31, 2005 (JP) 2005-105000

(51) Int. Cl. G09G 3/36

(52) U.S. Cl. 345/104

(57) ABSTRACT

According to one embodiment, an information processing apparatus includes a liquid crystal panel, a filter panel and a terminal. The liquid crystal panel includes a driver IC which displays an image on a display area. The filter panel is located opposite to a display surface of the liquid crystal panel, where the image is to be displayed, and is capable of displaying a privacy protection pattern for peek prevention. The terminal is mounted on an area on the filter panel, and to which a signal for driving the filter panel is to be supplied. The area on the filter panel is located opposite to an area which differs from the display area, and which includes an area on which the driver IC is mounted.

### CROSS-REFERENCE TO RELATED APPLICATIONS

This application is based upon and claims the benefit of priority from Japanese Patent Application No. 2005-105000, filed Mar. 31, 2005, the entire contents of which are incorporated herein by reference.

### BACKGROUND

1. Field

One embodiment of the invention relates to an information processing apparatus, for example, having a filter panel capable of displaying a privacy protection pattern for peek prevention is stacked on a display panel for displaying an image.

2. Description of the Related Art

In recent years, liquid crystal display apparatuses have been widely used as displays of notebook computers and various kinds of monitors. Their viewing angles have been improved; that is, they have been developed to have viewing angles having the same level as CRTs.

On the other hand, displays such as those of portable terminals are also each required to permit the displayed image to be viewed only from the front, i.e., not to permit the image to be viewed from either side, i.e., an oblique side, for the following reasons: when the user prepares or reads, for instance, a confidential document or information in a public place while seeing the display, it is necessary to prevent the document or information from being viewed by another person; and the user wants to read or write a personal mail, etc., without minding persons around the user.

As a technique controlling the viewing angle, there is provided a technique using a liquid crystal panel (which will be hereinafter referred to as a viewing angle control filter) having a liquid crystal material held by a pair of transparent substrates as disclosed in Jpn. Pat. Appln. KOKAI Publication No. 2004-13334. In the technique disclosed in this publication, when the viewing angle control filter is turned on, a privacy protection pattern for peek prevention pattern appears such that it can be viewed from an oblique angle to the display, thus preventing information such as characters on the display from being viewed from another person. In this case, even when the viewing angle control filter operates, when the information on the display can be viewed from the front, it can be done as it is; that is, the privacy protection pattern does not appear. Furthermore, when the viewing angle control filter is turned off, the image can be viewed as it is from any angle within the viewing angle of an image display panel which displays the image.

It is necessary to provide a terminal for supplying a drive signal for driving the viewing angle control filter, at the viewing angle control filter, and also to widen part of a glass substrate, where the terminal is provided. However, in order to maintain the bonding strength of the liquid crystal panel and the viewing angle control filter, the width of the above part of the glass substrate (on which the terminal is provided) cannot be simply increased.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing an example of the structure of a personal computer according to an embodiment of the present invention;

FIG. 2 is an exemplary view showing an example of a positional relationship between an LCD panel, a privacy filter and a double-faced adhesive tape;

FIG. 3 is an exemplary vertical sectional view showing an example of the structure of the double-faced adhesive tape;

FIG. 4 is an exemplary vertical sectional view showing the above example of the positional relationship between the LCD panel, the privacy filter and the double-faced adhesive tape;

FIG. 5 roughly shows an example of a structure for supplying a filter drive signal to the privacy filter;

FIG. 6A is an exemplary view showing how the image displayed by the LCD panel is viewed when the privacy filter is in the ON state;

FIG. 6B is an exemplary view showing how the image displayed by the LCD panel is viewed when the privacy filter is in the OFF state;

FIG. 7 is an exemplary view showing an example of a connection portion between a flexible printed circuit (FPC) and the privacy filter;

FIG. 8 is an exemplary view showing an example of the structure of a liquid cell of the LCD panel;

FIG. 9 is an exemplary view showing an example of the structure of a metal bezel of the LCD panel;

FIG. 10 is an exemplary view showing an example of the structure of the privacy filter;

FIG. 11A and FIG. 11B are exemplary views showing a relationship in size between the LCD panel and the privacy filter; and

FIG. 12 is an exemplary plan view showing that the LCD panel and the privacy filter are stacked together.

### DETAILED DESCRIPTION

Various embodiments according to the invention will be described hereinafter with reference to the accompanying drawings. In general, according to one embodiment of the invention, an information processing apparatus comprises a liquid crystal panel including a display area and a driver IC for displaying an image on the display area; a filter panel located opposite to the display area, the filter panel to be displayed a privacy protection pattern for peek prevention; and a terminal mounting on an area on the filter panel, and to which a signal for driving the filter panel being supplied, the area on the filter panel being located opposite to an area which differs from the display area, and which includes an area on which the driver IC is mounted.

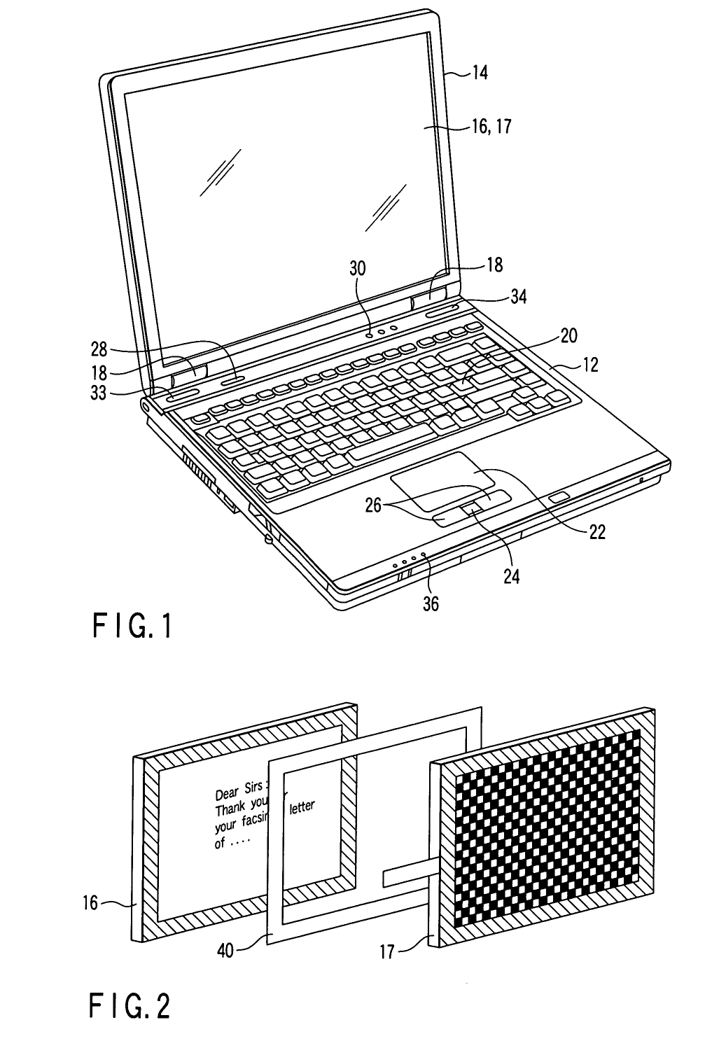

FIG. 1 is a view showing the structure of a notebook personal computer which is an information processing apparatus according to an embodiment of the present invention.

The personal computer comprises a computer body 12 and a display unit 14.

The display unit 14 is attached to hinges (supporting portions) 18 located at rear end portions of the computer body 12, such that it is rotatable between a closed position where the display unit 14 covers an upper surface of the computer body 12 and an open position where the display unit 14 does not cover the upper surface of the computer body 12, i.e., the upper surface thereof is exposed. The display unit 14 incorporates a liquid crystal display (LCD) panel 16 and a privacy filter (liquid crystal panel) 17. The LCD panel 16 serves as a display panel which displays an image on a display area in response to a panel drive signal, and the privacy filter 17 displays a privacy protection pattern for peek prevention in response to a filter drive signal.

The computer body 12 includes a box-shaped housing, and a keyboard 20 is provided at a center portion of an upper surface of the housing. At a front portion of the upper surface of the housing of the computer body 12, a palm rest is formed. At a substantially center portion of the palm rest, a touch pad 22, a scroll button 24 and touch pad control buttons 26 are provided. At a rear portion of the upper surface of the housing of the computer body 12, a power button for turning on/off a power supply provided in the computer body 12 therefor, a filter on-off switch 39, a left speaker 33 and a right speaker 34. At a front end portion of the upper surface of the housing, kinds of indicators (LEDs) 36 are provided which indicate the state of the power supply and the operation state of an HDD, etc., respectively.

As shown in FIG. 2, the privacy filter 17 is fixed to an image display surface of the LCD panel 16 by a double-faced adhesive tape (connecting member) 40. The double-faced adhesive tape 40 is located in such a way as to surround the display area of the LCD panel 16. In this case, preferably, the double-faced adhesive tape 40 should be provided without providing a gap between the double-faced adhesive tape 40 and the display area of the LCD panel 16.

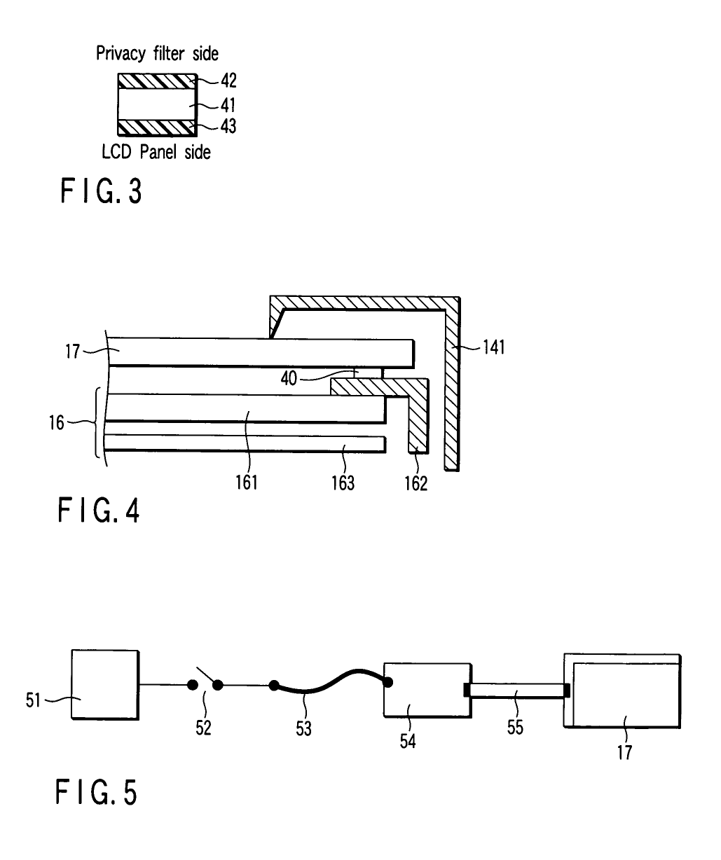

In the double-faced adhesive tape 40, as shown in FIG. 3, a thick tape-shaped member 41 having a cushioning function is provided, and adhesives 42 and 43 are provided on both sides of the tape-shaped member 41, respectively. It should be noted that as the adhesives 42 and 43, adhesives having the same adhesive force may be used, or adhesives having different adhesive forces may be used. For example, it is preferably that the adhesive force of the adhesive 42 on the privacy filter 17 be weaker than that of the adhesive 43 on the LCD panel 16. If so, the privacy filter 17 can be easily peeled off from the LCD panel 16. This is advantageous, for example, when the display unit is repaired.

The LCD panel 16 has a structure in which a liquid crystal cell 161 is held by a metal bezel 162 and a backlight unit 163 as shown in FIG. 4. The double-faced adhesive tape 40 is provided on a surface of the metal bezel 162. Further, the LCD panel 16 and the privacy filter 17 are provided in a housing 141 of the display unit 14.

FIG. 5 roughly shows a structure for supplying the filter drive signal to the privacy filter 17. As shown in FIG. 5, a flexible printed circuit (FPC) 55 is connected to a terminal for supplying the filter drive signal to the privacy filter 17. Since it is difficult that a linear cable is connected to the terminal, the FPC 55 is connected to the terminal. A power supply 51 provided in the computer body 12 produces the filter drive signal. The filter on-off switch 30 is provided on a line through which the filter drive signal is supplied from the power supply 51. A cable 53 is provided on the EPC side of the filter on-off switch 30.

The cable 53 is provided to extend from the computer body 12 into the display unit 14 through one of the hinges 18. Between the cable 53 and the FPC 55, a cable/FPC conversion substrate 54 for connecting a signal line of the cable 53 to a signal line of the FPC 55 is provided. The cable/FPC conversion substrate 54 and the FPC 55 are located in the display unit 14. It should be noted that as shown in FIG. 1, the filter on-off switch 30 is provided at the computer body 12; however, it may be provided at the display unit 14.

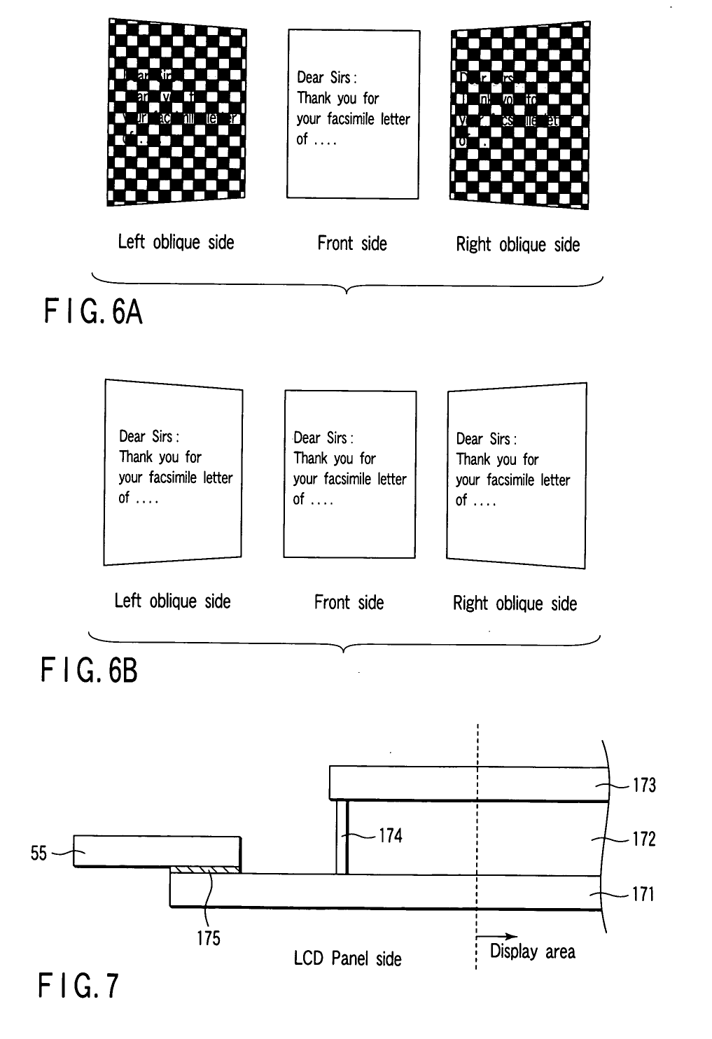

In accordance with the operation of the filter on-off switch 30, the privacy filter 17 is turned on/off. FIG. 6 shows an example of how an image on a screen of the display unit is viewed in the case where the privacy filter 17 is provided on the LCD panel 16. FIG. 6A shows three images viewed when the screen is viewed from respective sides, with the privacy filter 17 being in the ON state, and FIG. 6B shows three images viewed when the screen is viewed from the respective sides, with the privacy filter 17 being in the OFF state. Of the three images in each of FIGS. 6A and 6B, the left one is an image viewed when the screen is viewed from a left oblique side, the intermediate one is an image when the display is viewed from the front side, and the right one is an image when the screen is viewed from a right oblique side, with respect to the display unit. That is, the privacy filter 17 controls the amount of light traveling in a predetermined direction which is other than the direction of a substantial normal to a surface of the LCD 16, in accordance with the filter drive signal (voltage).

When the privacy filter 17 is in the ON state, as shown in FIG. 6A, a privacy protection pattern for peek prevention appears on the image displayed on the LCD panel 16, thereby preventing the image from being peeped at from sides other than the front side. At shown in FIG. 6A, even when the privacy filter 17 is in the ON state, the privacy protection pattern is not viewed from the front side, and the image displayed on the LCD panel 16 can be normally viewed.

It should be noted that if the FPC 55 were provided to extend through one of the hinges 18, it would be bent when the display unit 14 is opened or closed, thus lowering the reliability. Thus, in the embodiment of the present invention, the cable/FPC conversion substrate 54 is located in the display unit 14, and the cable 53 which has a high tolerance to a bending force is extended through one of the hinges. Thereby, disconnection hardly occurs even when the display unit 14 is opened or closed, thus restricting lowering of the reliability.

FIG. 7 shows a connection portion between the FPC 55 and the privacy filter 17. The FPC 55, as shown in FIG. 7, is bonded to or is in pressure contact with a side of the privacy filter 17 which is located opposite to the display surface thereof, i.e., a terminal 175 provided on a glass substrate (transparent substrate) 171 on the LCD panel side. It should be noted that referring to FIG. 6, a liquid crystal material 172 is provided between the glass substrate 171 and the a grass substrate 173. Furthermore, a seal 174 is provided to seal up the liquid crystal material 172 between the glass substrates 171 and 173.

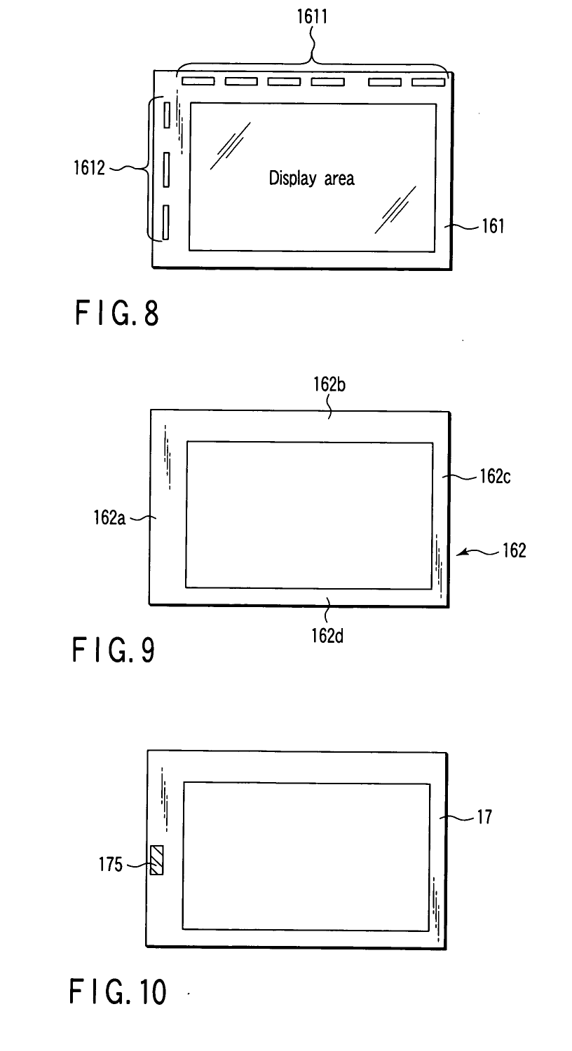

With respect to an ordinary LCD panel 16, the position of the terminal on the privacy filter side, to which the FPC 55 is to be connected, will be explained with reference to FIG. 8. In the liquid crystal cell 161 of the ordinary LCD panel 16, as shown in FIG. 8, a source driver IC 1611 and a gate driver IC 1612 are provided outward of the display area, to which the panel drive signal is to be supplied.

In order to supply the filter drive signal to the privacy filter 17, as shown in FIG. 7, it is necessary to provide the terminal 175 on an arbitrary glass substrate, which serves as I/F with the FPC 55, etc. As shown in FIG. 8, in the case where the LCD panel 16 is standardized by SPWG, VESA or the like, the source driver IC 1611 is located on an upper side, and the gate driver IC 1612 is located on a left side, with respect to the display area. As shown in FIG. 9, the metal bezel 162 covering an area of the LCD which is other than the display area is formed such that the width of each of areas 162a and 162b of the metal bezel 162, on which the drivers IC 1611 and IC 1612 are located, respectively, is greater than that of each of parts 162c and 162d of the metal bezel 162, on which the drivers IC 1611 and IC 1612 are not located.

It is preferable that the position of the terminal 175, to which the FPC 55 is connected, be determined in consideration of the positions of the drivers IC 1611 and IC 1612. That is, the terminal 175 is mounted on an area of the privacy filter 17, which is located to face an area of the LCD panel 16, which is other than the display area thereof, the above area of the privacy filter 17 including the areas of the LCD panel 16, on which the drivers IC 1611 and IC 1612 are mounted.

For example, as shown in FIG. 10, the terminal 175, to which the FPC or the like is connected to, is provided on the left side as viewed from the front side with respect to the display area of the privacy filter 17. The position of the terminal 175 corresponds to that of the gate driver IC 1612.

In order to provide the terminal 175, it is necessary to increase the size of part of the glass substrate 175, on which the terminal 175 is to be provided. When the terminal 175 is provided above one of the areas 162a and 162b of the metal bezel 162, which have a great width, the width of the above part of the glass substrate, on which the terminal 175 is to be provided, is increased. As a result, the overlapping area of the LCD panel 16 and the privacy filter 17 is also increased in order to ensure a high bending strength of the LCD panel 16 and the privacy filter 17. That is, the strength is increased.

On the other hand, in the case where the terminal 175 is located above one of the areas 162c and 162d on which the drivers IC 1611 and IC 1612 are not located, when the width of the glass substrate 171 is increased, the glass substrate 171 is projected from the LCD panel 16, thus lowering the strength. On the other hand, if the glass substrate 171 is located so as not to be projected from the LCD panel 16, it is troublesome to connect the FPC to the terminal 175.

Furthermore, space for the double-faced adhesive tape 40 for bonding the LCD panel 16 and the privacy filter 17 can be ensured.

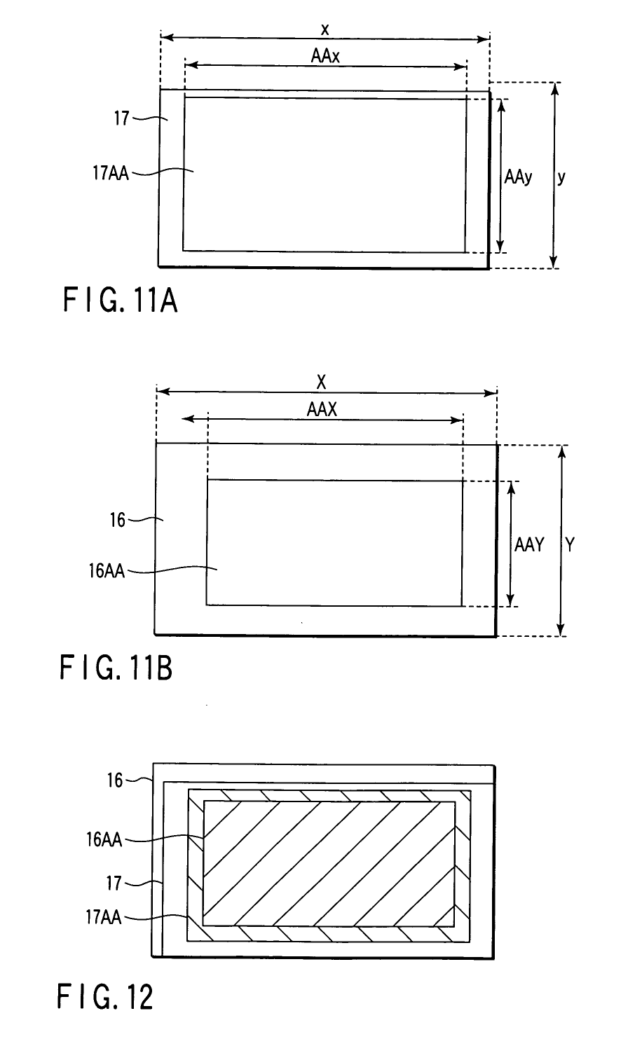

It should be noted that in the case where two panels having different functions are stacked together, the dimension tolerances of the LCD panel 16 and the privacy panel 17 and the mounting tolerances of the LCD panel 16 and the privacy panel 17 should be considered sufficiently. To be more specific, in the embodiment, in consideration of the dimension tolerances and mounting tolerances, the length and width (x, y) of the privacy filter 17 which is shown in FIG. 11A is set to be smaller than the length and width (X, Y) of the LCD panel 16 which is shown in FIG. 11B. That is, the following relationship is satisfied: x<X and y<Y.

Moreover, in view of the dimension tolerance and mounting tolerance of each of the LCD panel 16 and the privacy filter 17, the length and width (AAx, AAy) of a display area 17AA of the privacy filter 17, where the privacy protection pattern is to be displayed, are set to be greater than the length and width (AAX, AAY) of a display area 16AA of the LCD panel 16. That is, the following relationship is satisfied: AAx>AAX and AAy>AAY.

FIG. 12 is a plan view showing that the LCD panel 16 and the privacy filter 17 are stacked together.

In the personal computer according to the above embodiment, as stated above, the privacy filter 17 is bonded to the LCD panel 16 by using the double-faced adhesive tape 40 including the tape-shaped member 41. Thus, when a pressure is applied to the privacy filter 17, it is reduced by the above structure, thus preventing the glass substrate 171 from being torn, and also the privacy filter 17 from becoming unfunctional. Also, even in the case where the member 41 does not have a cushioning function, the privacy filter 17 is not broken, since the pressure does not concentratedly act on only part of the privacy filter 17.

Also, it should be noted that when the double-faced adhesive tape 40 is provided around the display area, a gap may be provided between the double-faced adhesive tape 40 and the display area. However, when the double-faced adhesive tape 40 is provided around the display area without providing a gap between the double-faced adhesive tape 40 and the display area, foreign matter or the like can be prevented from being introduced between the LCD panel 16 and the privacy filter 17.

Furthermore, when the LCD panel 16 and the privacy filter 17 are bonded to each other by the double-faced adhesive tape 40, the double-faced adhesive tape 40 is not projected from the LCD panel 16. Thus, the length and width of a combination of the LCD panel 16 and the privacy filter 17 does not exceed those of the LCD panel 16.

Also, by virtue of application of the double-faced adhesive tape 40, the LCD panel 16 and the privacy filter 17 can be bought separately. As a result, the LCD panel 16 can be also applied to a personal computer which does not incorporate the privacy filter 17. This advantage improves flexibility of manufacturing of personal computers, thus lowering the prices of LCD products and the management cost.

Furthermore, as stated above, the length and width of the privacy filter 17 is set to be smaller than that of the LCD panel 16. By virtue of this feature, it is also prevented that the privacy filter 17 cannot be bonded to the LCD panel 16 due to displacement of the privacy filter 17 from a predetermined position on the LCD panel 16. Thus, the time required for the manufacturing steps is shortened.

Also, since the length and width of the display area of the privacy filter 17 is set to be greater than that of the LCD panel 16, the privacy protection pattern of the privacy filter 17 can be necessarily located in its predetermined position with respect to the display area of the LCD 16.

It should be noted that an adhesive may be used in place of the double-faced adhesive tape to bond the privacy filter 17 to the LCD panel 16. Even if the adhesive is used, when a pressure is applied to the privacy filter 17, it does not concentratedly act only on part of the privacy filter 17, as a result of which the privacy filter 17 is not broken. When the adhesive is provided around the LCD panel 16, a gap may be provided between the adhesive and the LCD panel 16 or no gap may be provided between them. If the adhesive is provided around the LCD panel 16 without considering whether or not a gap is provided between them, and even if a gap is actually provided between them, it is minute, as a result of which foreign matter such as dust is not introduced between the LCD panel 16 and the privacy filter 17.

A filter for three-dimensional liquid crystal may be fixed to the LCD panel 16 in place of the privacy filter 17. Also, a liquid crystal cell may be fixed to the LCD panel 16 in place of the privacy filter 17. In this case, two images, i.e., a front image and a rear image, are displayed to produce a three-dimensional image.

As repeatedly stated, the privacy filter 17 is joined to the LCD panel 16. However, it can be also joined to a display having a panel surface on which a polarizing plate is provided, such as an organic EL panel.

The present invention is not limited to the above embodiment. When it is put to practical use, a structural element or elements in the embodiment may be modified without departing from the subject matter of the invention. Furthermore, various inventions can be made by appropriately combining structural elements in the embodiment. For example, some of all the structural elements in the embodiment can be omitted.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a display panel including a display area and a driver for displaying an image on the display area;
a filter panel located opposite to the display area, the filter panel to be displayed a pattern for peek prevention; and
a terminal mounting on an area on the filter panel, and to which a signal for driving the filter panel being supplied, the area on the filter panel being located opposite to an area which differs from the display area, and which includes an area on which the driver is mounted.

2. The information processing apparatus according to claim 1, which further comprising, a cable connected to the terminal, and through which a signal for driving the filter panel being supplied.

3. The information processing apparatus according to claim 2, further comprising,
a generating section configure to generate the signal for driving the filter panel,
a second cable being connected to the generating section, and
a conversion section which electrically connects the cable and the second cable.

4. The information processing apparatus according to claim 3, further comprising, a switch provided between the generating section and the conversion section.

5. The information processing apparatus according to claim 3, further comprising,
a body;
a display unit incorporating the display panel, the filter panel, the cable and the conversion section; and
a supporting portion supporting the display unit with respect to the body, and through which the second cable is provided to extend.

6. The information processing apparatus according to claim 1, wherein the filter panel includes a transparent substrate which is located opposite to the display panel, and the terminal is provided on the transparent substrate.

7. The information processing apparatus according to claim 1, wherein a length and a width of the filter panel is smaller than a length and a width of the display panel.

8. The information processing apparatus according to claim 1, wherein a length and a width of an area of the filter panel, on which the pattern is to be displayed, are greater than a length and a width of the display area of the display panel.

9. The information processing apparatus according to claim 1, wherein the pattern is a pattern which controls an amount of light traveling in a predetermined direction which is other than a direction of a normal to a surface of the display panel.

10. An information processing apparatus comprising:
a display panel configure to display an image on a display area thereof;
a filter panel located opposite to the display area, the filter panel being allowed to display a pattern for peek prevention; and
a joining member which being provided between the display panel and the filter panel to join the display panel and the filter panel to each other.

11. The information processing apparatus according to claim 10, wherein the joining member is provided around the display area.

12. The information processing apparatus according to claim 10, wherein the joining member includes a tape-shaped member and adhesives provided on both sides of the tape-shaped member.

13. The information processing apparatus according to claim 12, wherein the tape-shaped member has a cushioning function.

14. The information processing apparatus according to claim 12, wherein an adhesive force of one of the adhesives which is to be located on the display panel is different from that of the other of the adhesives which is to be located on the filter panel.

15. An information processing apparatus comprising:
a display panel which displays an image on a display area;
a filter panel which is located opposite to the display panel, the filter panel being allowed to be display a pattern for peek prevention; and
an adhesive member which is provided between the display panel and the filter panel, the adhesive member provided to bond the display panel and the filter panel to each other.

16. The information processing apparatus according to claim 15, wherein the adhesive member is provided around the display area.
